(19) United States
(12) Patent Application Publication
(10) Pub. No.: US 2005/0047872 A1
(43) Pub. Date: Mar. 3, 2005

(54) Deepwell reel

(76) Inventor: Benton F. Baugh, Houston, TX (US)

Correspondence Address: Benton F. Baugh, 14626 Oak Bend, Houston, TX, 77079, US

(21) Appl. No.: 10/653,140

(22) Filed: Sep. 3, 2003

(51) Int. Cl. F16L 1/00; B63B 35/03; E02B 17/08

(52) U.S. Cl. 405/158; 405/196; 405/154.1; 405/168.1

(57) ABSTRACT

A method of providing for seawater supply to an offshore jackup rig comprising suspending a pump from a hose which is unreeled from a reel on the jackup rig, the hose comprising fluid flow capacity for allowing seawater to be pumped from ocean depths up to the jackup rig, axial tensile capacity members within the wall of the hose to support the pump and the column of pumped water, and electricity carrying members within the wall of the hose to power the pump, a gland for the insertion of an electrical umbilical within the internal bore of the hose, and laying the hose horizontally on the deck of the jackup to insert the electrical umbilical within the hose.

### CROSS-REFERENCE TO RELATED APPLICATIONS

N/A

### STATEMENT REGARDING FEDERALLY SPONSORED RESEARCH OR DEVELOPMENT

N/A

### INCORPORATION-BY-REFERENCE OF MATERIAL SUBMITTED ON A COMPACT DISK

N/A

### BACKGROUND OF THE INVENTION

The field of this invention of that of special hose and reel assemblies for the support of jack-up rigs in the offshore oil and gas drilling industry. On land, drilling rigs simply sit on the ground. In very deep water, the rigs must float and are held in position by anchor lines or by dynamic position, which means running the propellers at all times.

Between dry land and deep offshore there is a shallow water situation in which a jackup rig can move to a location, put down legs, and literally jack itself out of the water. It will typically have an air gap of 20 to 50 feet between the bottom of the rig and the mean height of the ocean waves. In order to maintain this gap at different depths, the legs must have the ability to extend down different distances relative to the main structural section of the jackup rig.

Large supplies of seawater are required for three different functions on the jackup rig. First, when the jackup rig jacks itself out of the water, it pushes feet down into the mud. It is important that the legs be pushed down to a stable position, and the rig doesn't therefore settle down further while the well is being drilled. To accomplish this, a large amount of ballast sea water is pumped up into the rig ballast tanks to weight the rig down and drive the legs down to stable positions.

Secondly, there are requirements to cool the various engines around the rig, and the large amounts of cool seawater make this very efficient.

Thirdly, fire safety systems need a large supply of seawater for fire safety.

Each of these needs are beneficially handled by bringing large quantities of seawater from below the jackup rig and onto the deck for distribution.

One way this has been handled is to put a pump on one of the jacking legs. This is workable but provides plumbing problems with the unpredictability of the leg position. custom pumping or large flexible hoses are required to compensate for this unpredictability. Additionally, the pump is difficult to retrieve in case of need for servicing.

A second method has been a deepwell tower. This is similar to a fourth leg which is extended down near but not to the ocean floor. A deepwell tower is an expensive construction and provides the disadvantage of providing a large surface area in the wave zone. They are typically short lived and expensive to repair.

A third method has been to provide a reel and hose for the sea water flow, a reel and cable for the strength capacity, and a reel and hose for the electrical power lines. This makes for a complicated system with the reels being of different diameters and therefore different operating speeds. Additionally, the personnel are normally required to tape the various components together to unitize them as they are run.

### BRIEF SUMMARY OF THE INVENTION

The object of this invention is to provide a reel and hose assembly which will allow flow, power, and strength to be handled in a single member.

A second object of the present invention is to provide means to replace the electrical capacity of the hose with an internal electrical umbilical.

A third object of the present invention is to provide for the unitization of the replacement electrical umbilical with the hose in the vertical mode such that when the hose is reeled on the reel, the electrical umbilical will be of the proper length.

Another object of the present invention is to provide for the automatic stopping of the reel when the hose if fully deployed.

### BRIEF DESCRIPTION OF SEVERAL VIEWS OF THE DRAWINGS

FIG. 1 is a view of a jackup rig with the reel and hose of this invention shown on the deck with the pump deployed subsea.

FIG. 2 is a side view of the hose and the reel.

FIG. 3 is a front view of the hose and the reel.

FIG. 4 is a cross section of the hose assembly taken across the centerline of the hose.

FIG. 5 is a cross section of the hose taken along the centerline of the hose.

### DETAILED DESCRIPTION OF THE INVENTION

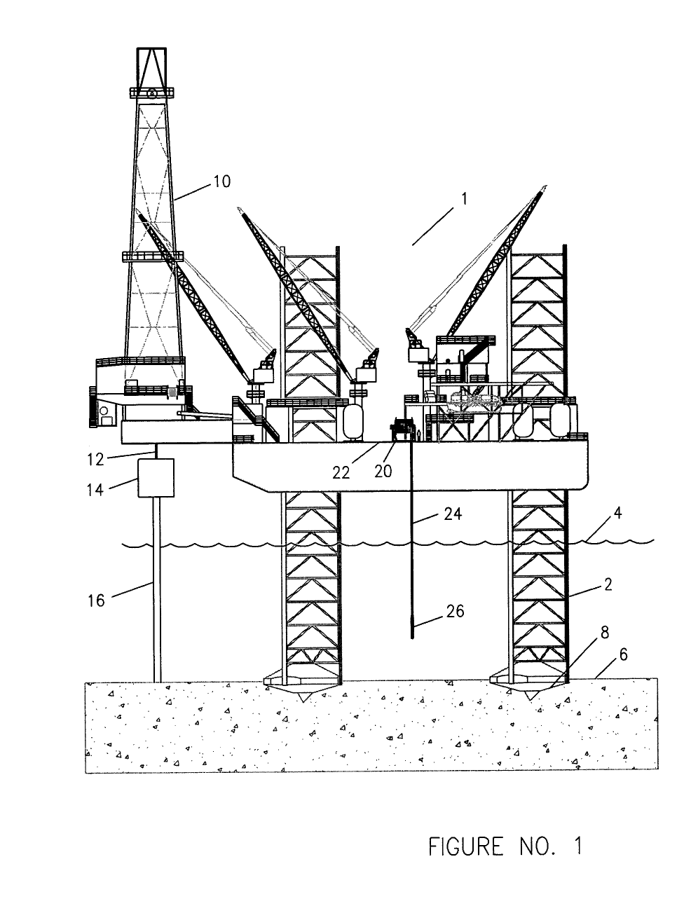

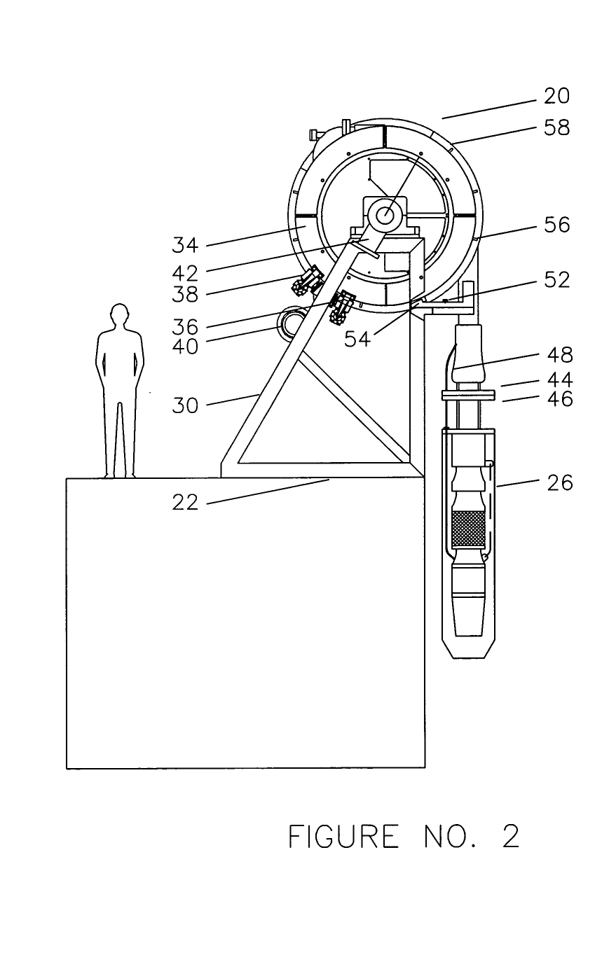

FIG. 1 shows a jackup rig 1 as would be landed on the ocean floor for the drilling of an oil or gas well. Legs 2 are shown going thru the ocean surface 4 and penetrating the seafloor 6 at 8.

Drilling rig 10 is shown supported on the jackup rig 1 with drill pipe 12 extending downwardly thru the blowout prevention equipment 14 and casing pipes 16.

Reel 20 is shown setting on the deck 22 of jackup rig 1 with hose 24 extending downwardly to the supported pump 26.

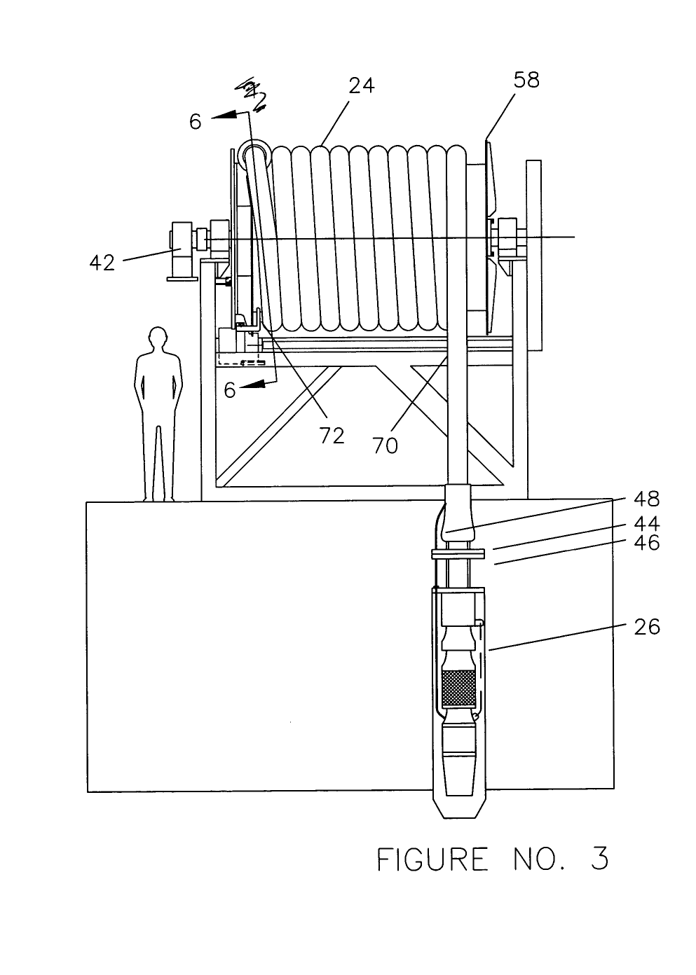

Referring now to FIG. 2, reel 20 is supported on deck 22 by frame 30 and provides brake drum 34, brake assemblies 36 and 38, drive motor 40, and swivel 42.

Hose 24 has a lower end 44 which connects directly to the upper end 46 of the pump 26. Wires 48 exit from the hose 24 to power the pump 26.

When arm 50 is moved out of the page the arm 50 pivots about axle 52 and causes the end 54 to move into the page and engage one of the ribs 56 on the side of the spool 58.

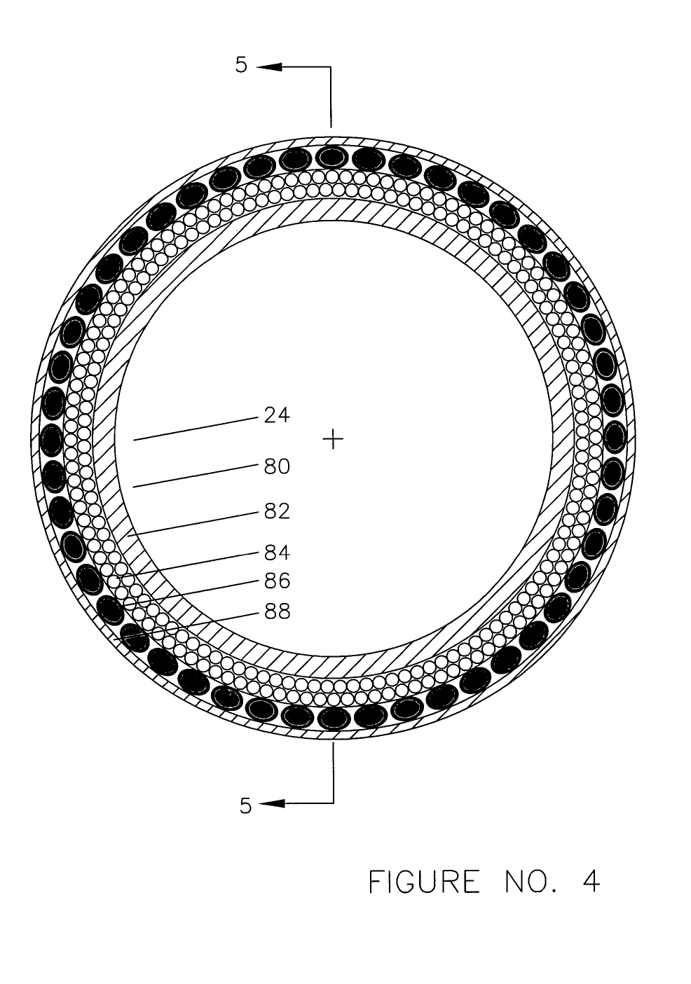

Referring now to FIG. 3, as the hose 24 is unreeled from the spool 58, the portion 70 of the hose 24 will effectively move to the left of the page. As it moves fully across, the portion 70 will hit the arm portion 72 and likewise push it to the left, causing the engaging motion described in the previous paragraph and therefore a stopping of further movement of the reel. This can be beneficially timed such that when the hose is completely extended to make full use of its length, it can be stopped automatically without the chance of damaging the hose by further movement under load.

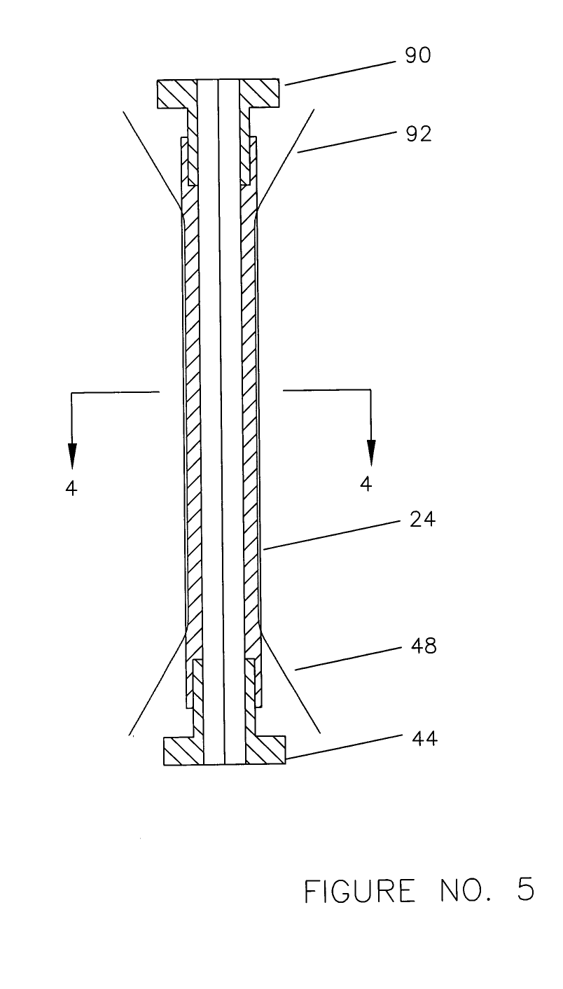

Referring now to FIG. 4, shows a cross section 80 of the hose assembly 24 of this invention with an inner liner 82 providing hydraulic sealing capability, two rows of tension members 84 for the axial strength of the hose, wires 86 for the conduction of electricity, and outer coating 88 for protection of the electrical wires. Several electrical wires are provided to allow multiple wires to carry the amperage load and therefore keep the diameter of the assembly smaller than would be with fewer larger diameter wires. Some of the wires are spares in case of problems with the initial wires.

The wires 86 are wrapped at a steep angle, i.e. 45°, such that when the hose is flexed, the wires will not be over stressed. This is why the wires appear to be ellipses in this view.

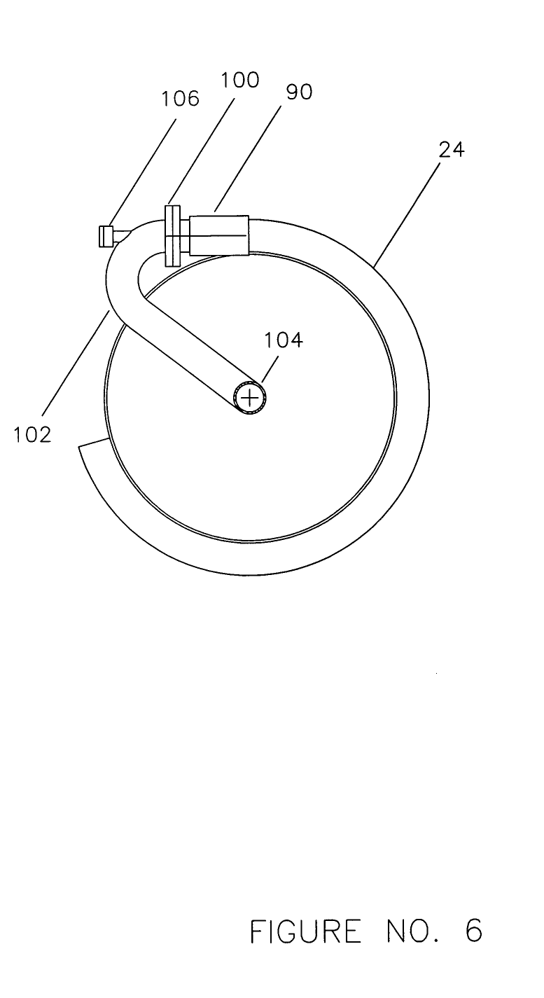

Referring now to FIG. 5, a cross section of the hose is taken at 90° to the cross section of FIG. 4 with mechanical connection ends 44 at the lower end and 90 at the upper end. Wires 48 exit the hose assembly near the lower connection end 44 for connection to the supported pump 26. Wires 92 exit the hose near the upper end connection 90 to be connected into the power lines at the surface.

FIG. 6 is a section taken along lines 6-6 of FIG. 3. with end connection 90 connected to reel connection 100. Connection 100 goes around bend 102 and down to the central pipe 104 for connection to swivel 42. As a backup assurance, port 106 provides a means to insert an electrical umbilical into the hose to extend down to the pump in case a large number of the wires in the wall fail. A similar gland (not shown) can be placed on the fittings directly above the pump to exit the umbilical for connection to the pump.

If the electrical umbilical is inserted into the hose, it is important that the length of the inserted umbilical is similar to the length of the hose itself. If it is too short, when the hose is deployed, the umbilical will be supporting the entire weight of the pump. If it is too long, it will be difficult to wrap up. To achieve the proper length is difficult to do when the hose is deployed because it is hard to make the bottom connection, although the cable can be inserted into the hose vertically as a matter of convenience. After insertion (or before horizontal insertion) the hose should be laid flat and straight on the deck to connect the two ends of the umbilical. In this way the length of the connected umbilical and the hose will naturally be similar.

The electrical wires can be simply used to power the pump or in some cases control signals may be interesting to send to the pump, e.g. to switch between pump sections being used. Alternately, it may be desired to have signals coming backup from the pump with information such as pump life expectancy, temperature, or leakage.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of providing for seawater supply to an offshore jackup rig comprising
suspending a pump from a hose which is unreeled from a reel on said jackup rig, said hose comprising
fluid flow capacity for allowing seawater to be pumped from ocean depths up to said jackup rig,
axial tensile capacity members within the wall of said hose to support said pump and the column of pumped water,
electricity carrying members within said wall of said hose to power said pump.

2. The invention of claim 1, wherein the movement of the portion of said hose depending directly from said reel causes an automatic stop to the rotation of said reel.

3. The invention of claim 1, further comprising a gland for the insertion of an electrical umbilical within the internal bore of said hose to provide power to operate said pump when said electricity carrying members fail.

4. The invention of claim 3, further comprising a gland proximate the lower end of said hose for the exit of said umbilical for connection to said pump.

5. The invention of claim 1, further comprising said electricity carrying members exiting said wall of said hose before said hose contacts the end fittings of said hose.

6. The invention of claim 1, further comprising said electricity carrying members within said wall of said carrying power to operate said pump.

7. The invention of claim 1, further comprising said electricity carrying members carrying signals to control said pump.

8. The invention of claim 1, further comprising said electricity carrying members carrying information from said pump to said jackup rig regarding the operations of said pump.

9. A method of providing for seawater supply to an offshore jackup rig comprising
suspending a pump from a hose which is unreeled from a reel on said jackup rig, said hose comprising
fluid flow capacity for allowing seawater to be pumped from ocean depths up to said jackup rig,
axial tensile capacity members within the wall of said hose to support said pump and the column of pumped water,
electricity carrying members within said wall of said hose to power said pump.
a gland for the insertion of an electrical umbilical within the internal bore of said hose, and
laying said hose horizontally on the deck of said jackup to insert said electrical umbilical within said hose.

10. The invention of claim 9, wherein the movement of the portion of said hose depending directly from said reel causes an automatic stop to the rotation of said reel.

11. The invention of claim 9, further comprising a gland proximate the lower end of said hose for the exit of said umbilical for connection to said pump. to provide power to operate said pump when said electricity carrying members fail.

12. The invention of claim 9, further comprising said electricity carrying members exiting said wall of said hose before said hose contacts the end fittings of said hose.

13. The invention of claim 9, further comprising said electricity carrying members within said wall of said carrying power to operate said pump.

14. The invention of claim 9, further comprising said electricity carrying members carrying signals to control said pump.

15. The invention of claim 9, further comprising said electricity carrying members carrying information from said pump to said jackup rig regarding the operations of said pump.

16. A method of providing for seawater supply to an offshore jackup rig comprising
suspending a pump from a hose which is unreeled from a reel on said jackup rig, said hose comprising
fluid flow capacity for allowing seawater to be pumped from ocean depths up to said jackup rig,
axial tensile capacity members within the wall of said hose to support said pump and the column of pumped water,
electricity carrying members within said wall of said hose to power said pump which said wall of said hose before said hose contacts the end fittings of said hose,
a gland for the insertion of an electrical umbilical within the internal bore of said hose to provide power to operate said pump when said electricity carrying members fail

17. The invention of claim 16, further comprising said electricity carrying members within said wall of said carrying power to operate said pump.

18. The invention of claim 16, further comprising said electricity carrying members carrying signals to control said pump.

19. The invention of claim 16, further comprising said electricity carrying members carrying information from said pump to said jackup rig regarding the operations of said pump.

20. The invention of claim 16, further comprising laying said hose horizontally on the deck of said jackup to insert said electrical umbilical within said hose.
